(19) United States
(12) Patent Application Publication
(10) Pub. No.: US 2026/0093541 A1
(43) Pub. Date: Apr. 2, 2026

(54) COMPUTER-READABLE RECORDING MEDIUM HAVING STORED THEREIN CALCULATION RESOURCE MANAGEMENT PROGRAM, CALCULATION RESOURCE MANAGEMENT METHOD, AND INFORMATION PROCESSING APPARATUS

(71) Applicant: Fujitsu Limited, Kawasaki-shi (JP)

(72) Inventors: Godai TAKASHINA, Matsudo (JP); Akihiro TABUCHI, Nakano (JP)

(73) Assignee: Fujitsu Limited, Kawasaki-shi (JP)

(21) Appl. No.: 19/329,706

(22) Filed: Sep. 16, 2025

(30) Foreign Application Priority Data
Sep. 30, 2024 (JP) 2024-171308

(51) Int. Cl. G06F 9/50

(52) U.S. Cl. CPC G06F 9/5027

(57) ABSTRACT

A non-transitory computer-readable recording medium having stored therein a calculation resource management program that causes a computer having a plurality of calculation resources to execute a process includes: acquiring a first identifier that identifies a calculation resource described in a deep learning application in a call to a deep learning framework during execution of the application; acquiring a second identifier corresponding to the first identifier with reference to a correspondence relationship between the first identifier and the second identifier, the second identifier identifying a physical calculation resource managed by the framework based on the first identifier; generating a new call by replacing the first identifier in the call with the acquired second identifier; and transmitting the new call to the framework.

### CROSS-REFERENCE TO RELATED APPLICATION

This application is based upon and claims the benefit of priority of the prior Japanese Patent application No. 2024-171308, filed on Sep. 30, 2024, the entire contents of which are incorporated herein by reference.

### FIELD

The present embodiment relates to a computer-readable recording medium having stored therein a calculation resource management program, a calculation resource management method, and an information processing apparatus.

### BACKGROUND

For example, it is known that processing performance is improved by using a graphics processing unit (GPU) instead of a central processing unit (CPU) to execute a deep learning (DL) application program (hereinafter referred to as a DL application). The CPU and GPU are examples of a calculation resource.

A programmer of the DL application performs explicit device designation in the DL application in order to have a benefit of a high-speed operation from a dedicated device such as the GPU.

In a case where a plurality of DL applications are simultaneously executed, when explicit device designations of different DL applications collide, resources are not allocated and a conflict occurs even when there is a margin for resources in the entire system. In order to utilize resources of the entire system, the programmer needs to ensure that the assignment of device IDs is consistent across cooperating DL applications in consideration of a hardware environment.

For example, a method of performing replacing the device ID in the DL application with a physical device ID by setting an environmental variable such as CUDA_VISIBLE_DEVICES is known.

For example, related arts are disclosed in US Patent Application Publication No. 2020/0301751, US Patent Application Publication No. 2012/0011520, Japanese National Publication of International Patent Application No. 2022-516486, and Japanese National Publication of International Patent Application No. 2007-531935.

### SUMMARY

According to an aspect of the embodiments, a non-transitory computer-readable recording medium having stored therein a calculation resource management program that causes a computer having a plurality of calculation resources to execute a process. The process includes: acquiring a first identifier that identifies a calculation resource described in a deep learning application in a call to a deep learning framework during execution of the application; acquiring a second identifier corresponding to the first identifier with reference to a correspondence relationship between the first identifier and the second identifier, the second identifier identifying a physical calculation resource managed by the framework based on the first identifier; generating a new call by replacing the first identifier in the call with the acquired second identifier; and transmitting the new call to the framework.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of hardware (HW) configuration of a computer that realizes functions of a calculation resource management system of an embodiment.

FIG. 2 is a diagram schematically illustrating a relationship between calculation resources and DL applications.

FIG. 3 is a diagram illustrating an example of dynamic change of a memory allocation amount in the calculation resource management system.

FIG. 4 is a diagram schematically illustrating a configuration of the calculation resource management system according to the embodiment.

FIG. 5 is a diagram illustrating a correspondence relationship between a virtual device ID and a physical device ID.

FIG. 6 is a diagram illustrating an example of tensor data for each virtual device ID.

FIG. 7 is a diagram illustrating an example of processing of moving the tensor data between devices.

FIG. 8 is a flowchart illustrating an example of processing by a device usage detector.

FIG. 9 is a flowchart illustrating an example of processing by a device correspondence manager.

FIG. 10 is a flowchart illustrating an example of processing by a scheduler.

FIG. 11 is a flowchart illustrating an example of processing by a tensor tracker/mover.

### DESCRIPTION OF EMBODIMENT(S)

By determining the assignment of a device IDs in advance in cooperation between DL applications, the DL application becomes code that depends on an execution environment, which reduces portability and makes it difficult to transparently apply the DL application to different execution environments. “To transparently apply the DL application” means that the DL application is applied basically without rewriting. In addition, there is a need to manually map the device IDs in the DL applications and physical device IDs, which is complicated.

Hereinafter, an embodiments according to the present calculation resource management program, calculation resource management method, and information processing apparatus will be described with reference to the drawings. However, the embodiments described below are merely illustrative, and are not intended to exclude the application of various modifications and techniques that are not explicitly described in the embodiments. For example, the present embodiment can be variously modified and implemented without departing from the scope thereof. Each drawing is not intended to include only the components illustrated in the drawing and may include other functions and the like.

### (A) Configuration

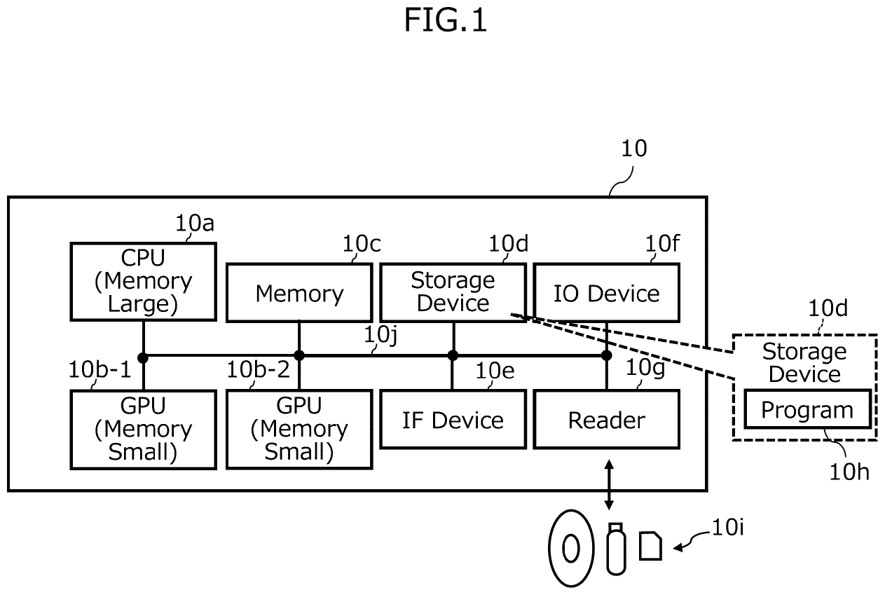

FIG. 1 is a block diagram schematically illustrating an example of hardware (HW) configuration example of a computer 10 that realizes functions of a calculation resource management system of an embodiment.

### [A-1] Hardware Configuration Example

In a case where a plurality of computers are used as HW resources that realize the functions of the calculation resource management system, each computer may have an HW configuration illustrated in FIG. 1.

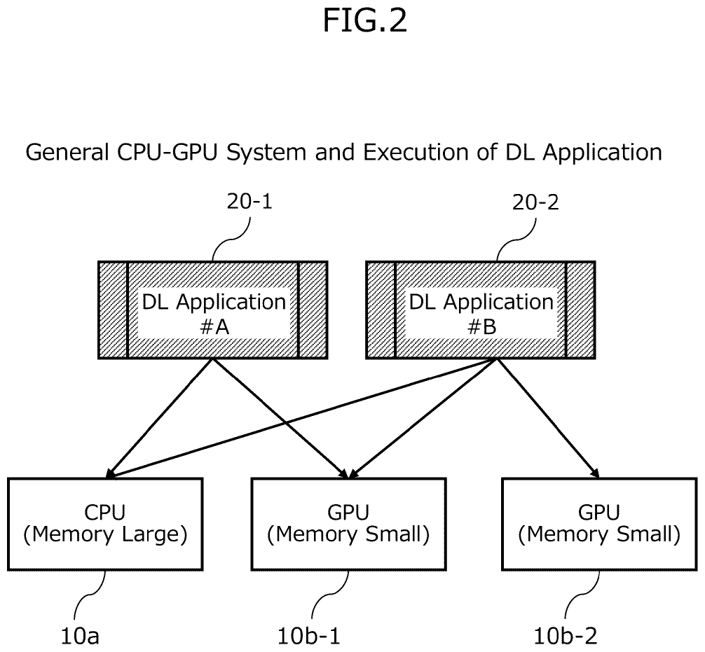

As illustrated in FIG. 1, the computer 10 is an information processing apparatus and may illustratively include, as the HW configuration, one or more (one in the example illustrated in FIG. 1) CPUs 10a, a plurality of (two in the example illustrated in FIG. 2) GPUs 10b-1 and 10b-2, a memory 10c, a storage device 10d, an interface (IF) Device 10e, an input/output (IO) Device 10f, and a Reader 10g. Hereinafter, the GPUs 10b-1 and 10b-2 will be referred to as GPUs 10b unless otherwise distinguished.

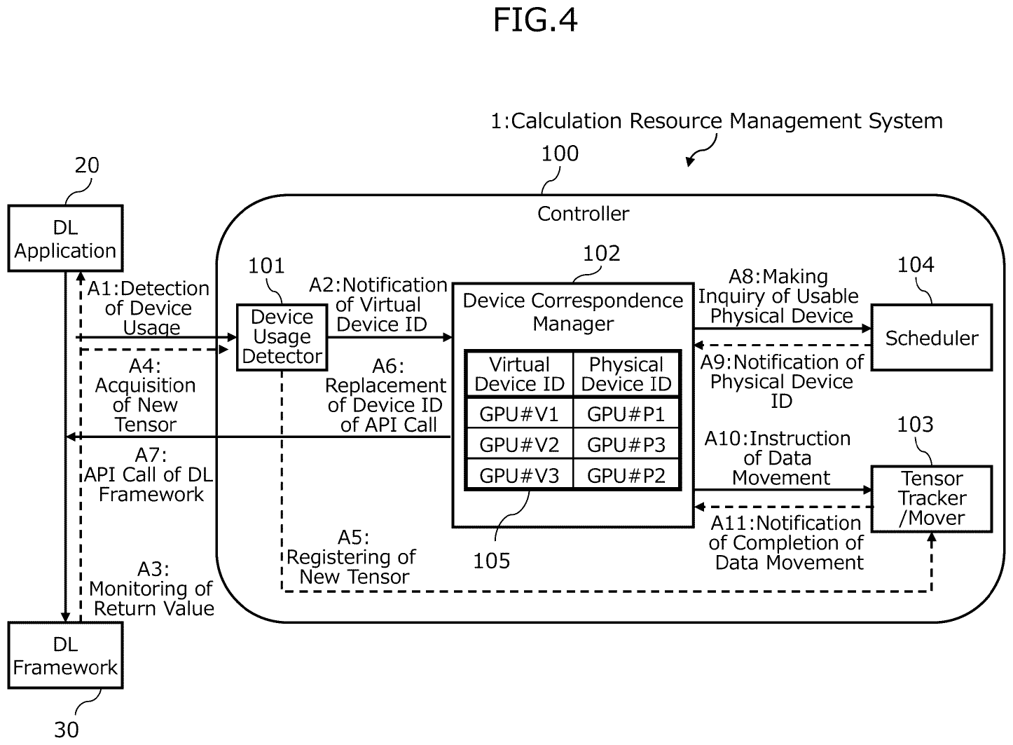

The CPU 10a is an example of an arithmetic processing device that performs various types of control and operations and is a controller (reference numeral 100 in FIG. 4) that executes various types of processing. The CPU 10a may be communicably connected to each block in the computer 10 via a bus 10j. The bus 10j may be a peripheral component interconnect-express (PCIe) bus. Note that the CPU 10a may be a multiprocessor including a plurality of processors, may be a multi-core processor including a plurality of processor cores, or may have a configuration including a plurality of multi-core processors.

The GPU 10b may be, for example, an accelerator such as a general purpose computing on graphics processing unit (GPGPU). In addition, the GPU 10b may be used to perform screen display control on an output device such as a monitor in the IO Device 10f. The GPU 10b may have a configuration as an accelerator that executes machine learning processing and inference processing using a machine learning model. Regarding the machine learning processing and the inference processing, the GPU 10b may have higher processing performance than the CPU 10a.

The CPU 10a, the GPU 10b-1, and the GPU 10b-2 are examples of calculation resources allocated to a DL application that is an application in the field of deep learning. The GPUs 10b-1 and 10b-2 are examples of first calculation resources, and the CPU 10a is an example of a second calculation resource having lower processing performance than the first calculation resource.

FIG. 2 is a diagram schematically illustrating a relationship between the calculation resources and DL applications 20-1 and 20-2. Hereinafter, the DL applications 20-1 and 20-2 will be referred to as DL applications 20 unless otherwise distinguished.

To execute each of the DL applications 20, not only the CPU 10a but also the GPUs 10b-1 and 10b-2 are used. The GPU 10b is used to perform a specific operation for DL at a high speed. In the present specification, a case where the GPU 10b is used as the accelerator (an acceleration device) will be described as an example.

The memory capacity of a main memory of the CPU 10a is larger than the memory capacity of a main memory of the GPU 10b. The main memory is a storage device from and to which devices such as the CPU 10a and the GPU 10b can directly read and write information.

Returning to FIG. 1, the memory 10c is an example of HW that stores various pieces of data and information of a program. Examples of the memory 10c include one or both of a volatile memory such as a dynamic random access memory (DRAM) and a nonvolatile memory such as a persistent memory (PM). The memory 10c may include the main memory of the CPU 10a and the main memory of the GPU 10b.

The storage device 10d is an example of HW that stores information such as various data and programs. Examples of the storage device 10d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), and a read only memory (ROM).

The storage device 10d may store a program 10h (calculation resource management program) that realizes all or a part of various functions of the computer 10.

For example, the CPU 10a of the calculation resource management system can realize a calculation resource management function by developing the program 10h stored in the storage device 10d in the memory 10c and executing the program, as will be described.

The IF Device 10e is an example of a communication IF that controls connection and communication between the present computer 10 and another computer. For example, the IF Device 10e may include an adapter conforming to a local area network (LAN) such as Ethernet□, optical communication such as fibre channel (FC), or the like. The adapter may support one or both of wireless and wired communication systems. Note that the program 10h may be downloaded from a network to the computer 10 via the communication IF and stored in the storage device 10d.

The IO Device 10f may include one or both of an input device and an output device. Examples of the input device include a keyboard, a mouse, and a touch panel. Examples of the output device include a monitor, a projector, and a printer. The IO Device 10f may include, for example, a touch panel that integrates an input device and an output device with each other. The output device may be connected to the GPU 10b. The IO Device 10f may be an input device or an output device of another information processing apparatus remotely connected to the computer 10 by a secure shell (SSH) or the like.

The Reader 10g is an example of a reader that reads information of data and programs recorded on the recording medium 10i. The Reader 10g may include a connection terminal or a device to which the recording medium 10i can be connected or inserted. Examples of the Reader 10g include an adapter conforming to a universal serial bus (USB) or the like, a drive device that accesses a recording disk, a card reader that accesses a flash memory such as an SD card, and the like. Note that the program 10h may be stored in the recording medium 10i, and the Reader 10g may read the program 10h from the recording medium 10i and store the program in the storage device 10d.

Examples of the recording medium 10i illustratively include a non-transitory computer-readable recording medium such as a magnetic/optical disk or a flash memory. Examples of the magnetic/optical disk include a flexible disk, a compact disc (CD), a digital versatile disc (DVD), a Blu-ray disc, and a holographic versatile disc (HVD). Examples of the flash memory include semiconductor memories such as a USB memory and an SD card.

The HW configuration of the computer 10 described above is exemplary. Accordingly, the computer 10 may appropriately undergo increase or decrease of the HW devices (for example, addition or deletion of an arbitrary block), division, integration in an arbitrary combination for the HWs, addition or deletion of a bus, or the like may be appropriately performed.

### (A-2) Functional Configuration Example

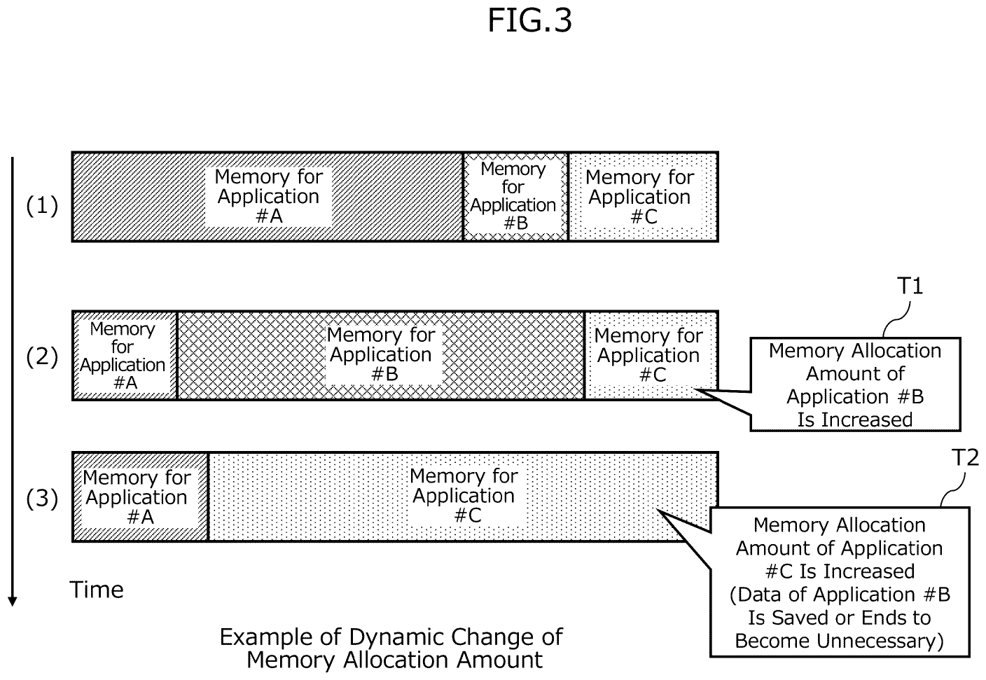

FIG. 3 is a diagram illustrating an example of dynamic change of a memory allocation amount in the calculation resource management system. During the execution of the DL application 20, a resource management technique according to the present embodiment dynamically changes a correspondence relationship between the calculation resources described in the DL application 20 and physical calculation resources such as the CPU 10a, the GPU 10b-1, and the GPU 10b-2 actually allocated.

In FIG. 3, the memory allocation amount for each of a plurality of DL applications #A, #B, and #C, as the DL application 20 is dynamically changed. In FIG. 3, the memory allocation amounts in time series in the order of (1), (2), and (3) are illustrated. In FIG. 3, during the execution of the DL application 20 (an application #A, an application #B, and an application #C in the figure), the calculation resource allocated to each DL application 20 is dynamically changed or updated according to the change in the process of the DL application 20 with the lapse of time. The calculation resource may include a memory allocation amount.

In (2), the memory allocation amount of the application #B is increased as compared with the case of (1) (see reference numeral T1). In addition, in (3), the memory allocation amount of the application #C is increased as compared with the case of (2) (see reference numeral T2). In (3), it is illustrated that there is no need for the memory allocation for the application #B when the data of the application #B is backed up in the main memory for a host (CPU 10a) or when the process ends (see reference numeral T2).

FIG. 4 is a diagram schematically illustrating a configuration of the calculation resource management system 1 according to the embodiment. In FIG. 4, the calculation resource management system 1 includes a controller 100.

The DL application 20 calls a function included in a DL framework 30. The DL framework 30 may mean software as a base for efficiently advancing deep learning, a general-purpose applicable design model, or a general-purpose processing pattern. The DL framework 30 may be a deep learning library. The DL framework 30 may be a framework such as TensorFlow, PyTorch, Keras, MXNet, and Chainer. The DL framework 30 is known, and the detailed description thereof is omitted here.

A device ID for identifying a device (calculation resource) used in the DL application 20 may be referred to as a virtual device ID. The virtual device ID may be explicitly (or implicitly) used (described) in the DL application 20. The virtual device ID is an example of a first identifier that identifies a calculation resource described in a deep learning application.

On the other hand, in the DL framework 30, a device ID that is recognized (managed) and identifies a device used for an operation may be referred to as a physical device ID. The physical device is an example of the physical calculation resource.

As illustrated in FIG. 4, the controller 100 includes a device usage detector 101, a device correspondence manager 102, a tensor tracker/mover 103, and a scheduler 104. However, the scheduler 104 may be implemented as a scheduler (not illustrated) which is an external system. In this case, it is also possible that the controller 100 does not include the scheduler 104.

Originally, the DL application 20 performs accessing such as reading with respect to the DL framework 30, but in the present calculation resource management system 1, the controller 100 functions as a relay module intervened between the DL application 20 and the DL framework 30.

The DL application 20 perform an application programming interface (API) call of the DL framework 30. The API is an interface that enables information and functions to be exchanged between software applications. The API exchanges data in the form of transmission of a call (request) and acquisition of a response. The API call of the DL framework 30 by the DL application 20 is an example of a call to the deep learning framework at the time of execution of the deep learning application.

The device usage detector 101 interrupts the API call of the DL framework 30 by the DL application 20 and detects the usage of the device on the basis of the API call (see an arrow A1 in FIG. 4). The device usage detector 101 acquires a tensor being used and a virtual device ID for identifying a device (calculation resource) described by the DL application 20 on the basis of the API call.

In addition, the device usage detector 101 notifies the device correspondence manager 102 of the acquired virtual device ID (see an arrow A2 in FIG. 4).

Note that the virtual device ID is used not only as a device ID held by a tensor used for the operation but also as a device ID indicating an output destination device of an output tensor.

The device usage detector 101 transmits the device usage notification to the device correspondence manager 102. The virtual device ID and tensor data may be included in the device usage notification.

The device usage detector 101 also acquires an “object in which data to be operated and information of a device in which the data is arranged are stored as a set” being used from the API call and notifies the device correspondence manager 102 of the acquired object. The object is referred to as a “tensor (tensor object)”. The virtual device ID may include a device ID held by the tensor (included in the tensor) and a device ID indicating an output destination device of the output tensor.

In addition, the device usage detector 101 monitors a return value which is a response from the DL framework 30 to the API call (see an arrow A3 in FIG. 4). In a case where the return value is a tensor, the device usage detector 101 acquires the tensor (see an arrow A4 in FIG. 4), notifies the tensor tracker/mover 103 to be described later of the tensor, and registers the tensor as a new tensor in the tensor tracker/mover (see an arrow A5 in FIG. 4).

The device correspondence manager 102 manages a correspondence relationship (mapping) between the virtual device ID and the physical device ID. The physical device ID is an example of a second identifier that identifies a physical calculation resource managed by the deep learning framework. The device correspondence manager 102 changes an allocation map 105, which is a correspondence relationship between the virtual device ID and the physical device ID, according to the execution status of the DL application 20.

When the corresponding physical device ID has already been determined for the virtual device ID notified from the device usage detector 101, the device correspondence manager 102 generates an API call of the DL framework 30 using the physical device ID. Specifically, the device correspondence manager 102 refers to the allocation map 105 and acquires the physical device ID corresponding to the notified virtual device ID. Then, using the acquired physical device ID, the device correspondence manager 102 replaces (that is, switches) the virtual device ID included in the DL framework API call with the physical device ID and generates a new API call (see an arrow A6 in FIG. 4). The device correspondence manager 102 sends the generated new API call to the DL framework 30 (see an arrow A7 in FIG. 4).

On the other hand, in a case where the corresponding physical device ID is not registered (not determined) in the allocation map 105, the device correspondence manager 102 makes an inquiry to the scheduler 104 (see an arrow A8 in FIG. 4) and secures a device such as the GPU 10b as a calculation resource corresponding to the process of the DL application 20. The scheduler 104 notifies the device correspondence manager 102 of the physical device ID of the secured device (see an arrow A9 in FIG. 4). The device correspondence manager 102 registers the physical device ID for identifying the secured device in the allocation map 105 as a new second identifier in association with the virtual device ID notified from the device usage detector 101.

Furthermore, the device correspondence manager 102 determines that a device such as the GPU 10b that is not used for a certain period of time is under suspension of usage and instructs the tensor tracker/mover 103 to back up the tensor to a host memory (see an arrow A10 in FIG. 4). The device correspondence manager 102 switches a backup-completed flag indicating that the tensor data has been backed up to ON or OFF.

The device correspondence manager 102 may further notify the scheduler 104 that the usage authority of the GPU 10b that is not used for a certain period of time is returned, delete the physical device ID of the GPU 10b from the allocation map 105, and update the allocation map 105.

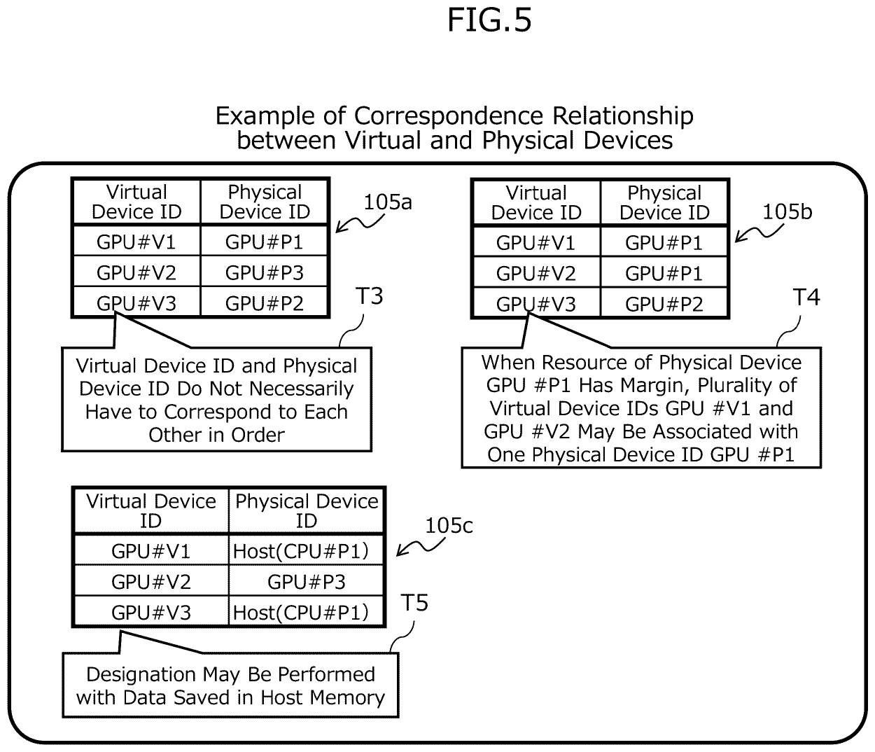

FIG. 5 is a diagram illustrating a correspondence relationship between a virtual device ID and a physical device ID. As illustrated in an allocation map 105a, Corresponding the virtual device ID and the physical device ID do not necessarily have to correspond to each other in order (number) (see reference numeral T3). For example, the scheduler 104 may appropriately allocate an available physical device (such as the GPU 10b) at the time of receiving an inquiry of the available physical device, and thus values (for example, numbers) used for the corresponding virtual device ID and physical device ID to each other do not necessarily coincide with each other.

Furthermore, as illustrated in an allocation map 105b, the correspondence relationship may include a relationship in which a plurality of virtual device IDs (in the example illustrated in FIG. 5, GPU #V1 and GPU #V2) are associated with one common physical device ID (in the example illustrated in FIG. 5, GPU #P1) (see reference numeral T4).

For example, in a case where the resource of the GPU #P1 (such as the memory allocation amount (memory capacity) of the main memory)) has a margin, the number of GPUs 10b (devices) used in one process can be reduced. For example, the DL application 20 using three GPUs 10b can be operated in a system having only two GPUs 10b.

Furthermore, as illustrated in an allocation map 105c, a relationship may be included in which the virtual device IDs (GPU #V1 and GPU #V3 in the example illustrated in FIG. 5) of the GPU 10b as the first calculation resources are associated with the physical device ID (in the figure, CPU #P1) of the CPU 10a (host) as the second calculation resource (see reference numeral T5). As a result, a function similar to that of a unified memory technology can be realized in a DL application layer. In this case, data corresponding to the GPU #V1 and the GPU #V3 is backed up in the host memory. As the physical device, it is possible to back up data and secure data on the CPU 10a (host) and to save a memory usage amount of the main memory of the GPU 10b.

The tensor tracker/mover 103 manages a tensor to be tracked. The tensor tracker/mover 103 tracks a tensor belonging to the virtual device ID and records a physical device in which actual data is present in tensor management information (not illustrated). The tensor tracker/mover 103 may manage the tensor for each virtual device ID. Note that the tensor management information may be included as a part of each tensor (D#1, D#2, . . .).

An instruction (data movement instruction) to back up the tensor to the host memory is input from the device correspondence manager 102 to the tensor tracker/mover 103 (see an arrow A10 in FIG. 4). In accordance with the data movement instruction from the device correspondence manager 102, the tensor tracker/mover 103 moves data of the tensor between the devices (that is, between the CPU 10a, the GPU 10b-1, and the GPU 10b-2) including the CPU 10a (host) before the tensor is used for an actual operation. The tensor tracker/mover 103 notifies the device correspondence manager 102 of the completion of the data movement (see an arrow A11 in FIG. 4).

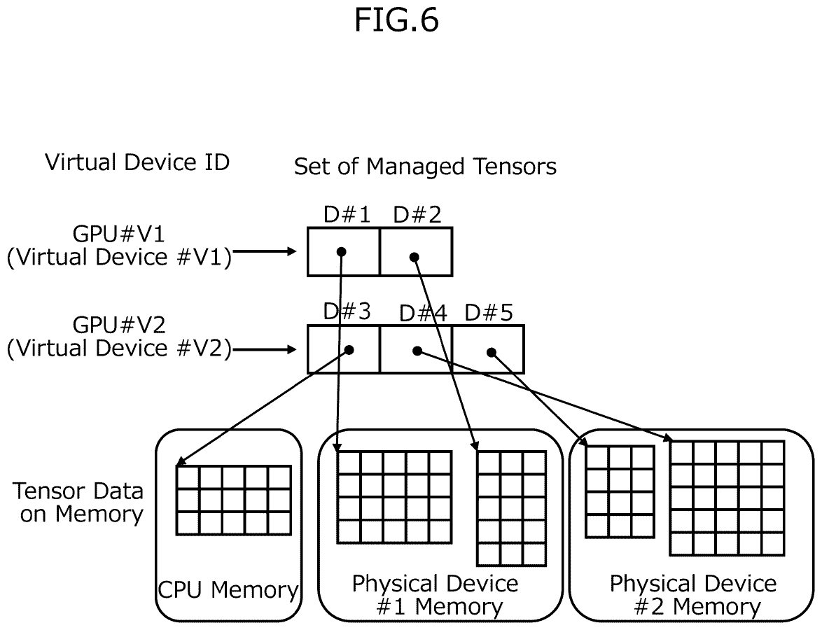

FIG. 6 is a diagram illustrating an example of the tensor data managed for each virtual device ID. In the example illustrated in FIG. 6, a set of managed tensors is associated with the virtual device ID, and a mapping in which a list of tensor objects is associated with each virtual device is created.

Specifically, the tensor objects D#1 and D#2 are managed for the virtual device (#V1) of which the virtual device ID is the GPU #V1. Furthermore, the tensor objects D#3, D#4, and D#5 are managed for the virtual device (#V2) of which the virtual device ID is the GPU #V2. Each of the tensor objects D#1 to D#5 includes a pointer (reference) to data present on the main memory of the CPU 10a or the main memory of the GPU 10b (in the figure, a physical device #1 memory and a physical device #2 memory). That is, each tensor object has a reference (pointer) to data present on the physical device.

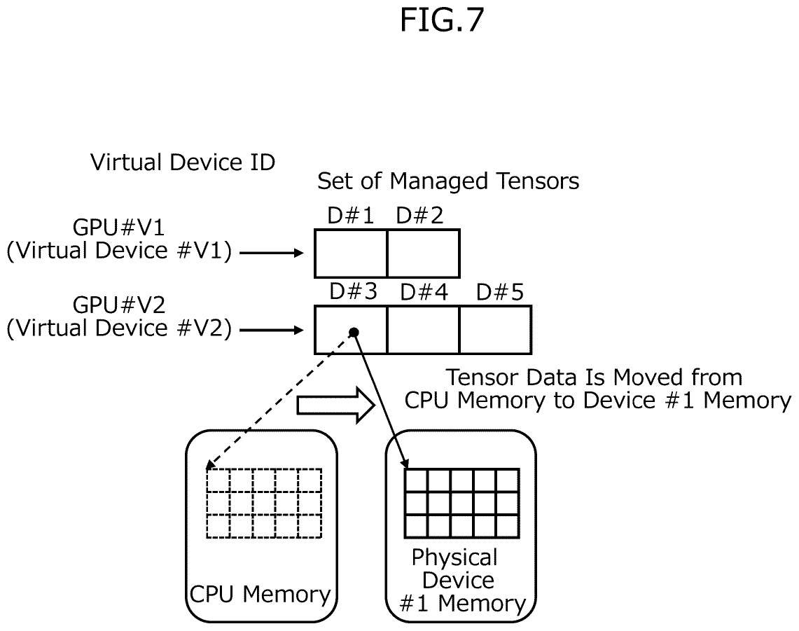

FIG. 7 is a diagram illustrating an example of processing of moving the tensor data between devices. In FIG. 7, an example is illustrated in which the tensor tracker/mover 103 moves the tensor data of the tensor object D#3 corresponding to the virtual device (#V2) of which the virtual device ID is the GPU #V2 from the main memory of the CPU 10a (CPU memory in the figure) to the main memory of the GPU 10b (physical device #1 memory in the figure). The tensor tracker/mover 103 may move the tensor data between the devices by changing the value of the pointer of the tensor data managed for each virtual device ID.

The scheduler 104 manages the calculation resources (devices such as the CPU 10a and the GPU 10b) of the entire system. In addition, an inquiry (device request) of an available physical device is input from the device correspondence manager 102 to the scheduler 104 (see an arrow A8 in FIG. 4). In response to the device request from the device correspondence manager 102, the scheduler 104 allocates a device (calculation resource) and notifies the device correspondence manager 102 of the physical device ID of the allocated device (see an arrow A9 in FIG. 4).

The scheduler 104 appropriately utilizes the calculation resources of the CPU 10a and the GPU 10b by preferentially allocating the GPU 10b in real time to a process for which high execution efficiency is expected even during program processing utilizing the GPU. The scheduler 104 exclusively allocates CPU 10a and GPU 10b to each process of the DL application 20 in terms of time in accordance with a request from the DL application 20.

In one example, the scheduler 104 registers the execution of the process as the management target of the allocation state of the GPU 10b that is the first calculation resource, and when a notification requesting the allocation of the GPU 10b is output from the process, determines whether there is the GPU 10b that can be allocated to the process. The scheduler 104 may allocate the process to the GPU 10b in a case where there is an allocatable GPU 10b and allocate the process to the CPU 10a that is the second calculation resource in a case where there is no allocatable GPU 10b.

### (B) Operation

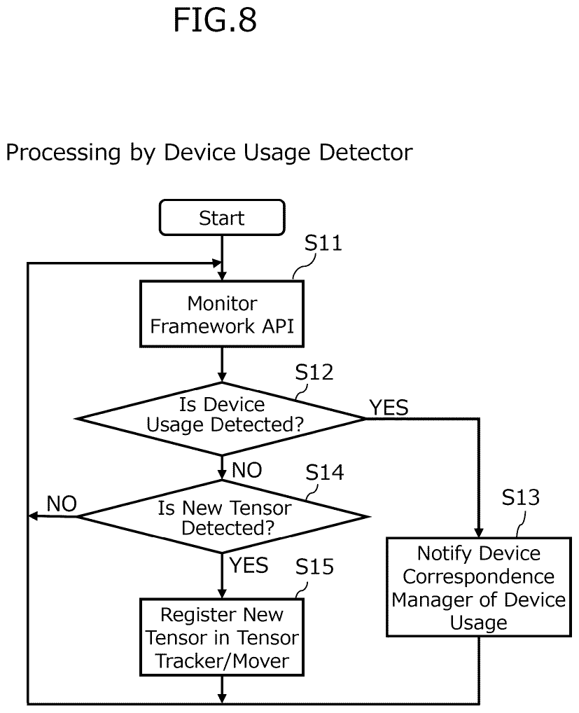

A calculation resource management method in the calculation resource management system 1 according to the embodiment configured as described above will be described with reference to FIGS. 8 to 11.

Processing of the device usage detector 101 of the calculation resource management system 1 according to the embodiment will be described with reference to the flowchart (steps S11 to S15) illustrated in FIG. 8. The device usage detector 101 monitors the DL framework API (step S11).

When detecting device usage (see YES route in step S12), the device usage detector 101 sends a device usage notification to the device correspondence manager 102 (step S13). Specifically, the device usage detector 101 acquires a virtual device ID for identifying a device (calculation resource) described in the DL application 20. The virtual device ID and tensor data may be included in the device usage notification. After the process of step S13 is executed, the process returns to step S11. In a case where the device usage is not detected (see NO route of step S12), the process proceeds to step S14.

When detecting a new tensor as a return value for the DL framework API call (see YES route in step S14), the device usage detector 101 notifies the tensor tracker/mover 103 of the new tensor and registers the new tensor in the tensor tracker/mover 103 (step S15). After the process of step S15 is executed, the process returns to step S11. When no new tensor is detected (see NO route in step S14), the process also returns to step S11.

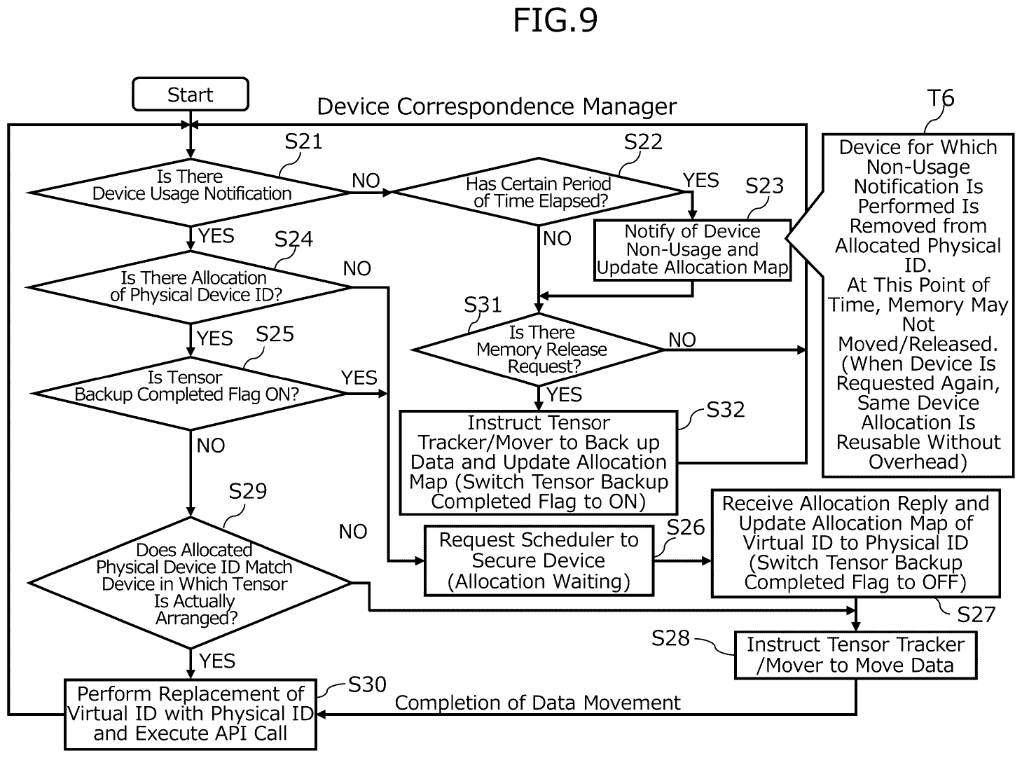

Processing of the device correspondence manager 102 of the calculation resource management system 1 according to the embodiment will be described with reference to the flowchart (steps S21 to S32) illustrated in FIG. 9.

In a case where the device correspondence manager 102 does not receive the device usage notification from the device usage detector 101 (see NO route in step S21) and in a case where the usage of the device is not checked even after a certain period of time has elapsed (see YES route in step S22), the process proceeds to step S23. When the certain period of time has not elapsed, step S23 is skipped, and the process proceeds to step S31.

In step S23, the device correspondence manager 102 may determine that a device such as the GPU 10b that is not used for a certain period of time is under suspension of usage, notify the tensor tracker/mover 103 of device non-usage, and instruct the tensor tracker/mover 103 to back up the tensor to main memory of the host (CPU 10a). In addition, the device correspondence manager 102 may notify the scheduler 104 of the device non-usage, return the usage authority of the GPU 10b, delete the physical device ID of the GPU 10b from the allocation map 105, and update the allocation map 105.

However, it is also possible that the tensor tracker/mover 103 does not immediately execute an instruction to back up (move) the tensor to the main memory of the host (CPU 10a) and release the memory (reference sign T6) even upon receiving the instruction. In a case where a usable physical device is requested again, the overhead can be reduced by allocating the same device.

When receiving the device usage notification from the device usage detector 101 (see YES route in step S21), the device correspondence manager 102 checks whether the physical device ID is allocated to the virtual device ID notified from the device usage detector 101 (step S24). When the corresponding physical device ID is allocated to the virtual device ID notified from the device usage detector 101 (YES route of step S24), the process proceeds to step S25.

In step S25, the device correspondence manager 102 may determine whether or not the tensor data is being backed up in the CPU 10a on the basis of whether or not the tensor backup-completed flag is ON. In a case where the tensor backup-completed flag is ON, that is, in a case where the tensor data is being backed up (see YES route in step S25), the process proceeds to step S26.

In addition, also in a case where the corresponding physical device ID has not been allocated (not registered) in step S24 (see NO route in step S24), the process proceeds to step S26.

On the other hand, in step S25, in a case where the tensor backup-completed flag is OFF (see NO route of step S25), the process proceeds to step S29.

In step S26, the device correspondence manager 102 requests the scheduler 104 to secure a device such as the GPU 10b as a calculation resource according to the process of the DL application 20.

When receiving an allocation reply including the allocated physical device ID from the scheduler 104, the device correspondence manager 102 updates the allocation map 105 by registering the physical device ID in the allocation map 105 in association with the virtual device ID (step S27). The device correspondence manager 102 switches the tensor backup-completed flag to OFF. Next, the device correspondence manager 102 instructs the tensor tracker/mover 103 to move data (step S28). As a result, as illustrated in FIG. 7, the data is moved from the backing up memory of the CPU 10a to the memory of the GPU 10b.

In a case where the allocated physical device ID does not match the device in which the tensor is actually arranged (see NO route in step S29), the device correspondence manager 102 instructs the tensor tracker/mover 103 to move data (step S28). Note that the device in which the tensor is actually arranged means a device in which the tensor is actually arranged at the processing time of step S28 as a result of the tensor movement performed by the tensor tracker/mover 103.

Basically, the device on which the tensor is arranged is the same as the device designated with the physical device ID. However, in the following case, the device in which the tensor is arranged may be different from the device designated with the physical device ID. For example, in a case where the scheduler 104 is notified of the device non-usage after a certain period of time has elapsed but the memory on the device has not yet been released, the device in which the tensor is arranged and the device designated by the physical device ID are different from each other. In this case, the physical device ID is deleted from the allocation map 105 such that the device is not used, but the tensor actually still remains arranged on the device. In this case, backup of memory contents is performed according to an additional request from the scheduler 104.

In the case of YES in step S29, the device correspondence manager 102 replaces the virtual device ID (first identifier) included in the API call with the physical device ID (second identifier) using the allocation map 105 (correspondence relationship), generates a new call, and executes the API call (step S30).

In addition, in step S31, in a case where a memory release request is received from the scheduler 104 (see YES route in step S31), the device correspondence manager 102 instructs the tensor tracker/mover 103 to back up data to the CPU 10a and updates the allocation map 105 (step S32). The device correspondence manager 102 switches a backup-completed flag indicating that the tensor data is backed up to ON. In a case where the memory release request is not made (see NO route in step S31) and in a case where the process in step S32 is completed, the process returns to step S21.

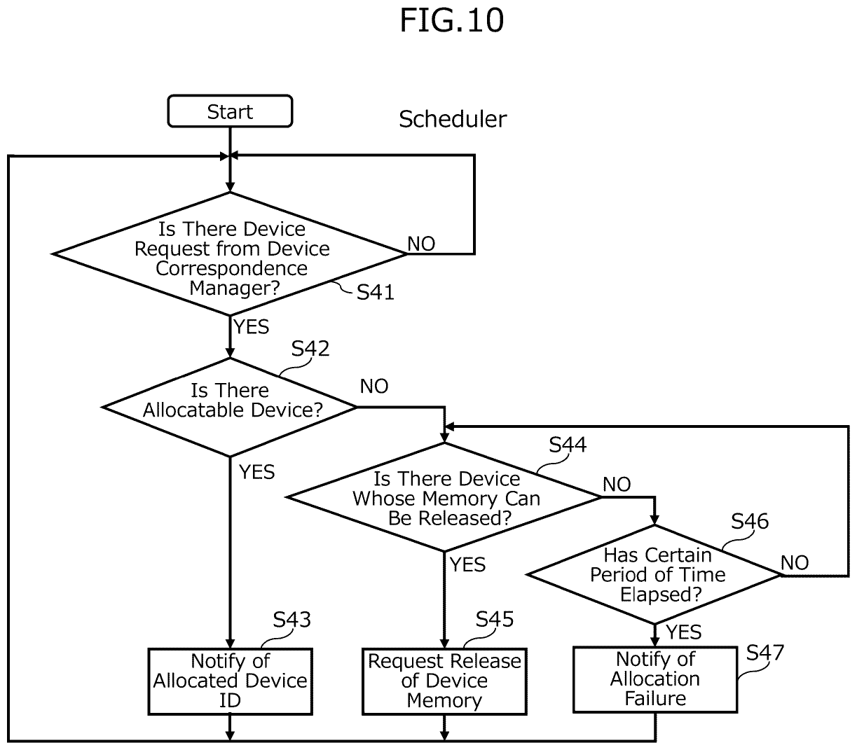

Next, processing by the scheduler 104 of the calculation resource management system 1 according to the embodiment will be described with reference to the flowchart (steps S41 to S47) illustrated in FIG. 10.

The scheduler 104 waits until there is a device request from the device correspondence manager 102 (see NO route in step S41).

Upon receiving the device request from the device correspondence manager 102 (YES route of step S41), the scheduler 104 determines whether there is an allocatable device (step S42). In a case where there is an allocatable device (see YES route in step S42), the scheduler 104 notifies the device correspondence manager 102 of the allocated physical device ID (step S43). Thereafter, the process returns to step S41.

In a case where there is no allocatable device (see NO route in step S42), the scheduler 104 determines whether there is a device whose memory can be released (step S44). In a case where there is a device whose memory can be released (see YES route in step S44), the scheduler 104 requests the device correspondence manager 102 to release the device memory (step S45). Thereafter, the process returns to step S41.

On the other hand, in a case where there is no device whose memory can be released (see NO route in step S44), the scheduler 104 then checks whether a certain period of time has elapsed since the start of determination as to whether there is a device whose memory can be released (step S46).

In a case where a certain period of time has elapsed, that is, in a case where it is not possible to obtain the device whose memory can be released for the certain period of time or more (see YES route in step S46), the process proceeds to step S47. The scheduler 104 notifies the device correspondence manager 102 of allocation failure (step S47). Thereafter, the process returns to step S41.

In a case where a certain period of time has not elapsed in step S46 (see NO route in step S46), the process returns to step S44. However, the scheduler 104 may be configured to notify the allocation failure without waiting for the elapse of a certain period of time. That is, the process of step S46 may be omitted. Note that the elapse of a certain period of time may be designed as a timeout for the calling side of the scheduler 104, that is, the device correspondence manager 102. In this case, the starting point of the certain period of time may be a point of time when the device request (allocation request) reaches the scheduler 104.

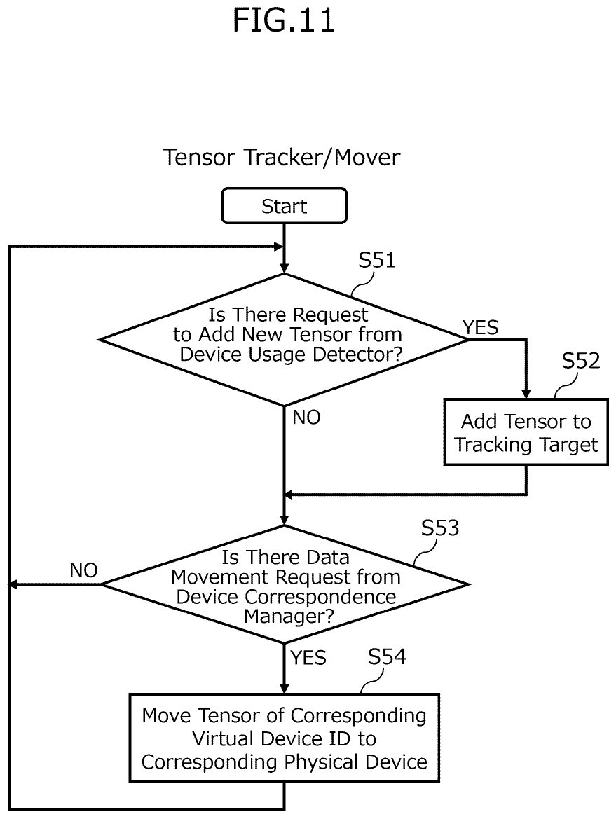

Next, processing of the tensor tracker/mover 103 of the calculation resource management system 1 according to the embodiment will be described with reference to the flowchart (steps S51 to S54) illustrated in FIG. 11.

Upon receiving a request to add a new tensor of the return value of the DL framework API call from the device usage detector 101 (see YES route in step S51), the tensor tracker/mover 103 adds the tensor to the tracking target (step S52). Thereafter, the process proceeds to step S53. In addition, also in a case where the request to add a new tensor of the return value of the DL framework API call has not been received from the device usage detector 101 in step S51 (see NO route in step S51), the process proceeds to step S53.

The tensor tracker/mover 103 checks whether a data movement request has been received from the device correspondence manager 102 (step S53). In a case where the tensor tracker/mover 103 receives the data movement request from the device correspondence manager 102 (see YES route of step S53), the process of step S54 is executed.

In step S54, the tensor tracker/mover 103 moves all the tensor data of the corresponding virtual device ID for which the data movement request is performed to the corresponding physical device. Thereafter, the process returns to step S51. Also in a case where the tensor tracker/mover 103 has not received the data movement request from the device correspondence manager 102 in step S53 (see NO route of step S53), the process returns to step S51.

### (C) Effects

As described above, the calculation resource management system 1 as an example of the embodiment acquires the first identifier (virtual device ID) that identifies the calculation resource described in the DL application 20 in the call to the DL framework 30 during execution of the DL application 20. The calculation resource management system 1 refers to a correspondence relationship (allocation map 105) between the first identifier and the second identifier (physical device ID), the second identifier identifying the physical calculation resource managed by the DL framework 30 based on the first identifier, and acquires the second identifier corresponding to the first identifier. The calculation resource management system 1 generates a new call by replacing the first identifier in the original call with the second identifier and transmits the new call to the framework.

As a result, in the DL application 20, it is possible to designate the GPU 10b that executes the DL application 20 transparently and dynamically. The calculation resource management system 1 does not need to change the DL application 20 and the DL framework 30. There is no need to fix the relationship between the virtual device ID and the physical device ID with an environmental variable or the like before execution in the DL application 20.

Even in a case where the plurality of DL applications 20-1 and 20-2 are executed, the programmer does not need to perform the conservative memory allocation assuming a peak memory amount (worst case) for each of the DL applications 20-1 and 20-2. Therefore, a decrease in the utilization rate of the calculation resource can be suppressed.

In the general technique, it is assumed that the memory of the GPU 10b continues to be occupied during execution of a job regardless of whether or not the calculation is being performed by the GPU 10b. For example, the DL application 20 may continue to place parameters and the like of a deep learning model on the GPU 10b, or the DL framework 30 may continue to internally secure the memory of the GPU 10b regardless of whether or not the deep learning model is used from the DL application 20. On the other hand, according to the present embodiment, the scheduler 104 can control the allocation of the GPU 10b such that the allocation of the GPU 10b does not overlap in terms of time or in consideration of the memory usage amount even in a case where the allocation of the GPU 10b overlaps in terms of time. Therefore, since the programmer of the DL application 20 can program the memory of the GPU 10b to be fully used, there is no need to perform the conservative memory allocation as described above.

Note that it is also conceivable to simultaneously perform the allocation of GPU 10b to the plurality of DL applications 20 within an allowable range of the memory of GPU 10b without being temporally exclusive, but also in this case, the scheduler 104 performs scheduling in consideration of the memory usage amount. Therefore, in the DL application 20, basically, there is no need to consider interference due to memory usage of another job.

Since the controller 100 relays between the DL application 20 and the DL framework 30 in the application layer of DL application 20, the controller 100 can instruct backup (transfer) of data to the host memory in the application layer. Therefore, it is possible to prevent data transfer from being performed at timing not preferable for execution of the DL application 20. Therefore, it is possible to suppress the influence on the performance degradation of the DL application 20.

On the DL framework 30, it is difficult to change the allocation of the devices ID, in other words, the correspondence relationship between the virtual device ID and the physical device ID, but there is a technology called AntMan that realizes transparent data movement in the main memories of the CPU 10a and the GPU 10b by performing reconstruction to the DL framework 30 (14th USENIX Symposium on Operating Systems Design and Implementation, Nov. 4 to 6, 2020, Wencong Xiao et al., [Internet] www.usenix.org/conference/osdi20/presentation/xiao). In this respect, according to the calculation resource management system 1 of the present embodiment, unlike AntMan or the like, it is possible to omit the reconstruction to the DL framework 30, and thus, it is easy to implement. Since there is no need to perform the reconstruction in accordance with the development of the main body of the DL framework 30, an increase in a maintenance load can be suppressed.

Note that a general technique such as a virtual memory in a field such as an operating system (OS) is known, but the calculation resource management system 1 of the present embodiment is in a DL field and is realized in a DL application layer. Therefore, according to the calculation resource management system 1, it is easy to perform resource distribution and scheduling according to the execution characteristic of the DL application 20. In addition, the implementing cost and the introduction cost can be reduced. Further, the portability of the DL application 20 can be enhanced.

The programmer of the DL application 20 can describe the explicit or implicit device designation in a manner independent of the particular hardware environment. The programmer can designate the device allocation without worrying about interference from other jobs. Specifically, the programmer can designate the device allocation without worrying about the memory capacity becoming insufficient due to oversubscription of the memory.

The calculation resource management system 1 changes the allocation map 105 based on the execution status of the application. Therefore, it is possible to dynamically change the allocation of the devices according to the execution status of the application.

Even in a case where a plurality of types of calculation resources of the first calculation resource (CPU 10a) and the second calculation resource (GPU 10b) described in the DL application 20 are included, the CPU 10a and the GPU 10b to execute the DL application 20 can be designated transparently and dynamically.

The allocation map 105c includes at least a relationship in which the virtual device ID that identifies the first calculation resource (GPU 10b) is associated with the physical device ID that identifies the second calculation resource (CPU 10a). As a result, it is possible to back up data and secure data on the CPU 10a (host) side and to save a memory usage amount of the main memory of the GPU 10b. A technology similar to a unified memory technology that reduces complexity of data movement between the CPU 10a and the GPU 10b can be realized in the application layer. Since the timing of the data movement between the CPU 10a and the GPU 10b can be controlled from the DL application 20, it is possible to suppress the performance deterioration of the DL application 20 depending on the execution pattern of the data movement.

Note that the unified memory is a part of functions of a general-purpose parallel computing platform (parallel computing architecture) and a programming model (for example, CUDA) for the GPU provided by a GPU vendor and is a technology that transparently moves a memory between devices with respect to a memory secured by a specific API.

In addition, there is a technology called TGS (20th USENIX Symposium on Networked Systems Design and Implementation, Apr. 17 to 19, 2023, Bingyang Wu, et al., [Internet] www.usenix.org/conference/nsdi23/presentation/wu). The TGS is a technology for replacing a normal GPU memory securing call in a program with a memory securing API for the unified memory (at the time of execution) such that a benefit of memory management by the unified memory can be obtained without changing an application. The usage of the unified memory basically needs a change of the application (rewriting of the memory securing API or the like), but in the TGS, a replacement corresponding to the above replacement is transparently performed at the time of execution (in a device driver layer), and thus there is no need for the change of the application.

However, in the case of the TGS, since a method of acquiring information (application context) related to execution of an application is limited (only behavior seen from the outside can be known), for example, in a DL framework called TensorFlow, it is sometimes attempted to secure a memory much more than the actual usage, but it is difficult to find a really needed memory amount only by observation from the outside. In addition, as described above, since it is not possible to control the memory movement timing by the unified memory, the performance of the application may be affected depending on the execution pattern. In the present embodiment, these problems can be solved.

The allocation map 105b may include a relationship in which a plurality of virtual device IDs are associated with one common physical device ID. For example, in a case where the memory allocation amount (memory capacity) of the main memory of the GPU 10b has a margin, the number of GPUs 10b (devices) used in one process can be reduced. For example, the DL application 20 using three GPUs 10b can be operated in a system having only two GPUs 10b.

In a case in which the physical device ID corresponding to the virtual device ID is not registered in the allocation map 105, the scheduler 104 secures the physical device corresponding to the process of the DL application 20. The device correspondence manager 102 registers the physical device ID for identifying the secured physical calculation resource in the allocation map 105. Since the scheduler 104 manages the entire calculation resources of the system, a status in which the GPUs 10a used between the plurality of DL applications 20-1 and 20-2 conflict with each other and a memory shortage occurs is prevented in advance. Thus, the programmer can designate the device allocation without worrying about interference by other jobs.

### (D) Others

Each configuration and each process of the present embodiment can be selected as needed, or may be appropriately combined.

The disclosed technology is not limited to the above-described embodiments, and various modifications can be made without departing from the gist of the present embodiment.

For example, in the above-described embodiments, the computer 10 constituting the calculation resource management system 1 is used as a single calculation node, and the DL application is executed on the computer 10, but the present invention is not limited thereto. A cluster configuration including a plurality of calculation nodes (computers 10) may be formed, and the calculation resource management system 1 may be constructed using this cluster configuration.

Furthermore, in the above-described embodiments, the configuration example in which the computer 10 includes one CPU 10a and two GPUs 10b-1 and 10b-2 is illustrated, but the present invention is not limited thereto. At least one of the CPU 10a and the GPU 10b may be provided in one, two, or three or more.

Furthermore, according to the disclosure described above, the present embodiment can be carried out and manufactured by those skilled in the art.

In one aspect, the present embodiment can designate a calculation resource for transparently executing a deep learning application.

Throughout the specification, the claims, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a calculation resource management program that causes a computer having a plurality of calculation resources to execute a process comprising:
acquiring a first identifier that identifies a calculation resource described in a deep learning application in a call to a deep learning framework during execution of the application;
acquiring a second identifier corresponding to the first identifier with reference to a correspondence relationship between the first identifier and the second identifier, the second identifier identifying a physical calculation resource managed by the framework based on the first identifier;
generating a new call by replacing the first identifier in the call with the acquired second identifier; and
transmitting the new call to the framework.

2. The non-transitory computer-readable recording medium according to claim 1, wherein the process further comprises changing the correspondence relationship based on an execution status of the application.

3. The non-transitory computer-readable recording medium according to claim 1, wherein each of the calculation resource and the physical calculation resource described in the application include a first calculation resource and a second calculation resource having lower processing performance than the first calculation resource.

4. The non-transitory computer-readable recording medium according to claim 3, wherein the correspondence relationship includes at least a relationship in which the first identifier that identifies the first calculation resource is associated with the second identifier that identifies the second calculation resource.

5. The non-transitory computer-readable recording medium according to claim 1, wherein the correspondence relationship includes a relationship in which a plurality of the first identifiers are associated with the second identifier that is common to the plurality of first identifiers.

6. The non-transitory computer-readable recording medium according to claim 1, wherein the process further comprises:
securing the physical calculation resource according to a process of the application in a case where the second identifier corresponding to the first identifier is not registered in the correspondence relationship; and registering the second identifier that identifies the secured physical calculation resource in the correspondence relationship.

7. A computer-implemented calculation resource management method comprising:
in a computer having a plurality of calculation resources,
acquiring a first identifier that identifies a calculation resource described in a deep learning application in a call to a deep learning framework during execution of the application;
acquiring a second identifier corresponding to the first identifier with reference to a correspondence relationship between the first identifier and the second identifier, the second identifier identifying a physical calculation resource managed by the framework based on the first identifier;
generating a new call by replacing the first identifier included in the call with the acquired second identifier; and
transmitting the new call to the framework.

8. The computer-implemented calculation resource management method according to claim 7, further comprising changing the correspondence relationship based on an execution status of the application.

9. The computer-implemented calculation resource management method according to claim 7, wherein each of the calculation resource and the physical calculation resource described in the application include a first calculation resource and a second calculation resource having lower processing performance than the first calculation resource.

10. The computer-implemented calculation resource management method according to claim 9, wherein the correspondence relationship includes at least a relationship in which the first identifier that identifies the first calculation resource is associated with the second identifier that identifies the second calculation resource.

11. The computer-implemented calculation resource management method according to claim 7, wherein the correspondence relationship includes a relationship in which a plurality of the first identifiers are associated with the second identifier that is common to the plurality of first identifiers.

12. The computer-implemented calculation resource management method according to claim 7, further comprising:
securing the physical calculation resource according to a process of the application in a case where the second identifier corresponding to the first identifier is not registered in the correspondence relationship; and
registering the second identifier that identifies the secured physical calculation resource in the correspondence relationship.

13. An information processing apparatus having a plurality of calculation resources, the apparatus comprising:
a memory; and
a processor coupled to the memory, the processor being configured to execute a process including:
acquiring a first identifier that identifies a calculation resource described in a deep learning application in a call to a deep learning framework during execution of the application;
acquiring a second identifier corresponding to the first identifier with reference to a correspondence relationship between the first identifier and the second identifier, the second identifier identifying a physical calculation resource managed by the framework based on the first identifier;
generating a new call by replacing the first identifier in the call with the acquired second identifier; and
transmitting the new call to the framework.

14. The information processing apparatus having a plurality of calculation resources according to claim 13, wherein the process further comprises changing the correspondence relationship based on an execution status of the application.

15. The information processing apparatus having a plurality of calculation resources according to claim 13, wherein each of the calculation resource and the physical calculation resource described in the application include a first calculation resource and a second calculation resource having lower processing performance than the first calculation resource.

16. The information processing apparatus having a plurality of calculation resources according to claim 15, wherein the correspondence relationship includes at least a relationship in which the first identifier that identifies the first calculation resource is associated with the second identifier that identifies the second calculation resource.

17. The information processing apparatus having a plurality of calculation resources according to claim 13, wherein the correspondence relationship includes a relationship in which a plurality of the first identifiers are associated with the second identifier that is common to the plurality of first identifiers.

18. The information processing apparatus having a plurality of calculation resources according to claim 13, wherein the process further comprises:
securing the physical calculation resource according to a process of the application in a case where the second identifier corresponding to the first identifier is not registered in the correspondence relationship; and
registering the second identifier that identifies the secured physical calculation resource in the correspondence relationship.
